(19) United States
(12) Patent Application Publication
(10) Pub. No.: US 2024/0024899 A1
(43) Pub. Date: Jan. 25, 2024

(54) SPRINKLER SPRAY PLATE

(71) Applicant: NELSON IRRIGATION CORPORATION, Walla Walla, WA (US)

(72) Inventor: Michael R. TOWNSEND, Waitsburg, WA (US)

(21) Appl. No.: 18/224,300

(22) Filed: Jul. 20, 2023

Related U.S. Application Data
(60) Provisional application No. 63/390,788, filed on Jul. 20, 2022.

(51) Int. Cl. B05B 3/04

(52) U.S. Cl. CPC B05B 3/0486

(57) ABSTRACT

A deflector plate includes a flat or convex deflector surface and a plurality of deflector grooves extending radially outward from the deflector surface. The deflector surface is configured to deflect water outward into the plurality of deflector grooves.

### CROSS-REFERENCES TO RELATED APPLICATIONS

This application claims the benefit of U.S. Provisional Patent Application No. 63/390,788, filed Jul. 20, 2022, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a deflector plate for a sprinkler assembly and, more particularly, to a deflector spray plate including a flat deflector surface.

Multi-stream spray plates or deflector plates are well known. In a typical configuration, a water stream from a nozzle is directed toward the deflector plate, which includes a plurality of grooves or channels. Water impacting the deflector plate is directed into the channels for distribution in multiple streams. The channels may be configured such that the water causes the deflector plate to rotate.

Due to manufacturing tolerances, there are instances when the deflector plate is not properly aligned with the nozzle output. That is, the nozzle bore may not be lined up with the deflector plate shaft. This consequence can result in more water flowing to one side of the sprinkler than the other.

Misalignment of the deflector plate becomes more significant with smaller nozzles.

### SUMMARY

It would thus be desirable to provide a deflector plate for a sprinkler assembly that takes potential misalignment and manufacturing tolerances into consideration. According to the described embodiments, a deflector plate may be provided with a flat or slightly conical deflector surface that reduces side-to-side variations in water distribution. It has been discovered that the flat deflector surface causes water impacting the surface to spread evenly and provides for more consistent distribution into the deflector grooves of the deflector plate for multi-stream irrigation.

In some embodiments, notches in a central opening are provided with knife edges secured to the flat deflector surface that prevent debris from getting hung up in the central opening. The knife edges also serve to separate and direct the water from the flat deflector surface into the deflector grooves.

In an exemplary embodiment, a deflector plate for a sprinkler assembly includes a central opening with a plurality of notches extending radially outward, a flat deflector surface positioned adjacent the central opening, and a plurality of deflector grooves extending radially outward from the flat deflector surface and in communication with the plurality of notches.

The notches may be arrayed circumferentially about the central opening, and side walls of adjacent ones of the notches may meet at a point to define an inward-facing edge. In this context, radially outermost walls of the notches may extend farther outward than an outermost periphery of the flat deflector surface.

The deflector grooves may be configured to create rotational torque on the deflector plate when water is deflected into the deflector grooves by the flat deflector surface.

The central opening and the notches may be disposed on a nozzle-facing side of the deflector plate, and the deflector grooves may be disposed on an opposite side of the deflector plate. The deflector grooves may extend through an outer circumference of the deflector plate on the opposite side of the deflector plate. The deflector plate may include a rotation hub on the opposite side of the deflector plate.

In some embodiments, the flat deflector surface is circular.

The notches may be spaced from the flat deflector surface.

The central opening and the deflector grooves may be configured such that a water stream flowing through the central opening and impacting the flat deflector surface is deflected outward into the deflector grooves. In this context, the central opening and the deflector grooves may be configured such that the water stream flows into the central opening on a nozzle-facing side of the deflector plate and exits the deflector grooves on an opposite side of the deflector plate.

In another exemplary embodiment, a deflector plate includes a flat or convex deflector surface and a plurality of deflector grooves extending radially outward from the deflector surface. The deflector surface is configured to deflect water outward into the plurality of deflector grooves.

The deflector surface may include a flat surface. The deflector plate may include a radiused area in each of the deflector grooves at radial outermost edges of the deflector surface.

In some embodiments, the deflector surface may include a rounded convex surface.

The deflector surface and the plurality of deflector grooves may be disposed on a nozzle-facing side of the deflector plate.

In yet another exemplary embodiment, a sprinkler includes a base unit coupleable with a source of water under pressure, a nozzle disposed in the base unit, and the deflector plate of the described embodiments coupled with the base unit and disposed facing the nozzle.

### BRIEF DESCRIPTION OF THE DRAWINGS

These and other aspects and advantages will be described in detail with reference to the accompanying drawings, in which:

FIGS. 1 and 2 show the deflector plate of the described embodiments installed in a sprinkler assembly;

FIG. 3 is a top view of the deflector plate;

FIG. 4 is a bottom view of the deflector plate;

FIG. 5 is a sectional view of the deflector plate;

FIG. 6 is a sectional view of the sprinkler assembly showing a water flow path;

FIGS. 7-8 show a variation with the grooves on a nozzle side of the deflector plate;

FIGS. 9-10 show a variation using a rounded deflecting surface; and

FIGS. 11-13 show a two-piece version of the deflector plate.

### DETAILED DESCRIPTION

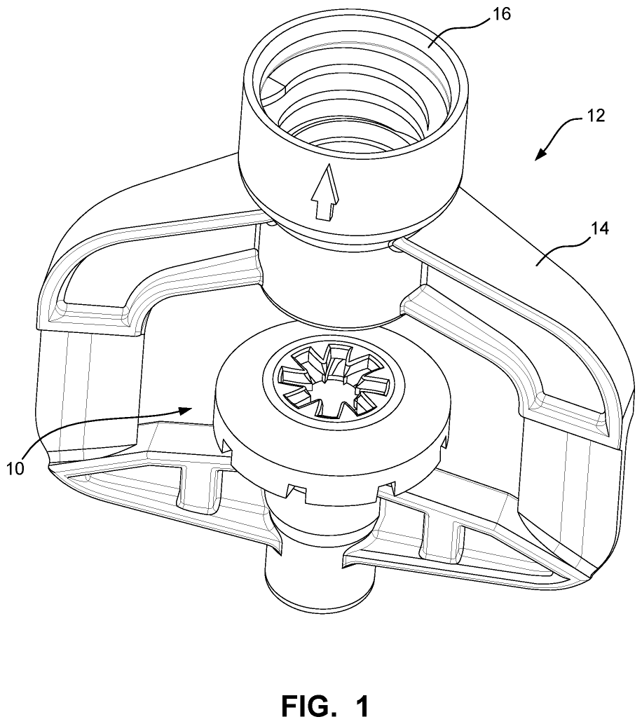

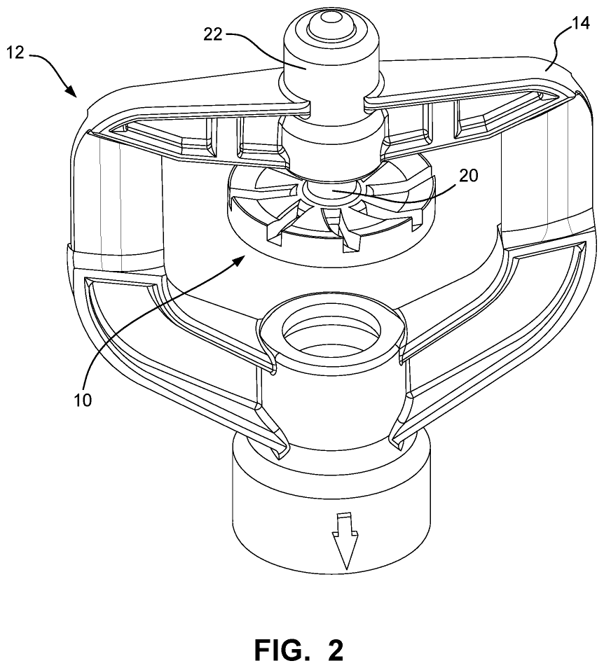

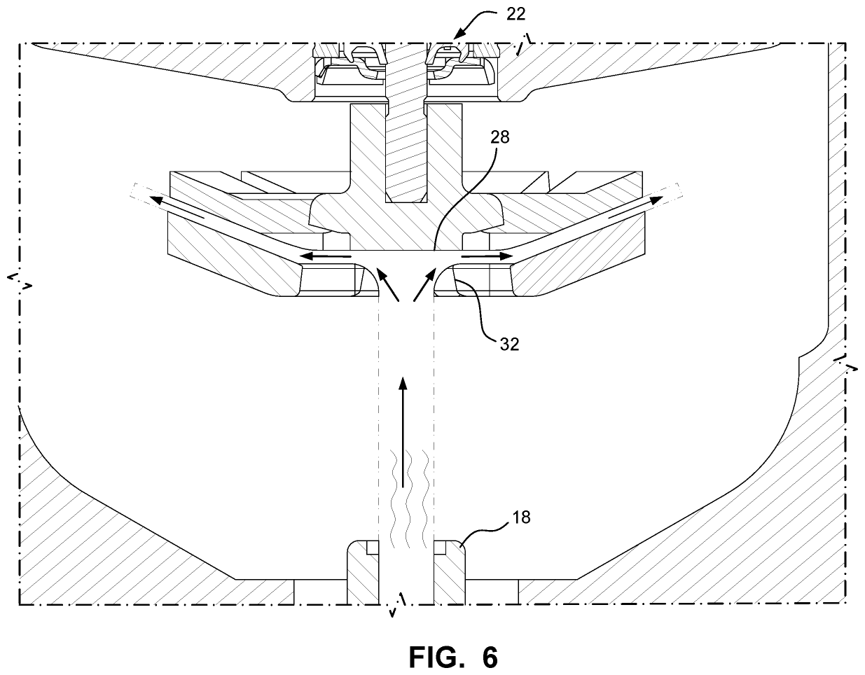

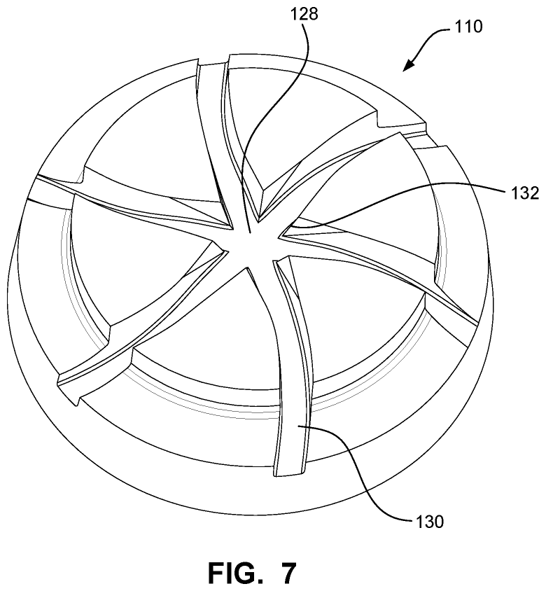

FIGS. 1 and 2 show the deflector plate 10 of the described embodiments installed in a sprinkler assembly 12. The sprinkler assembly 12 includes a base unit 14 coupleable with a source of water under pressure via a threaded connector 16. Water flows through a nozzle 18 (FIG. 6) disposed in the base unit 14.

The deflector plate 10 is coupled with the base unit 14 and is disposed facing the nozzle 18.

The deflector plate 10 is secured to the base unit 14 via a rotation hub 20. (See FIG. 2.) In some embodiments, the rotation hub is secured to a rotation speed-limiting device 22 to control a rotation speed of the deflector plate 10 during use.

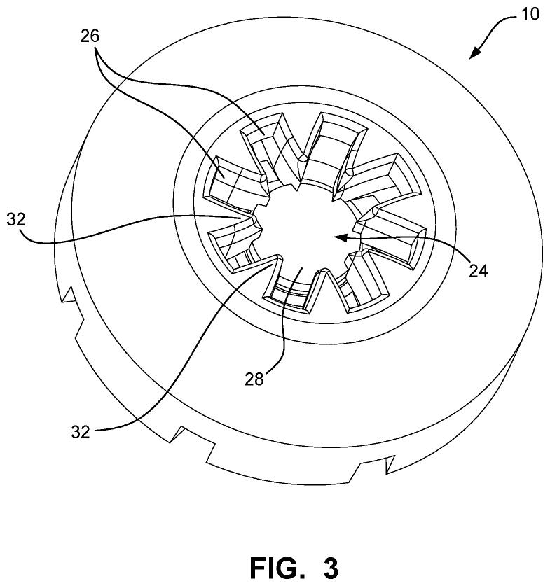

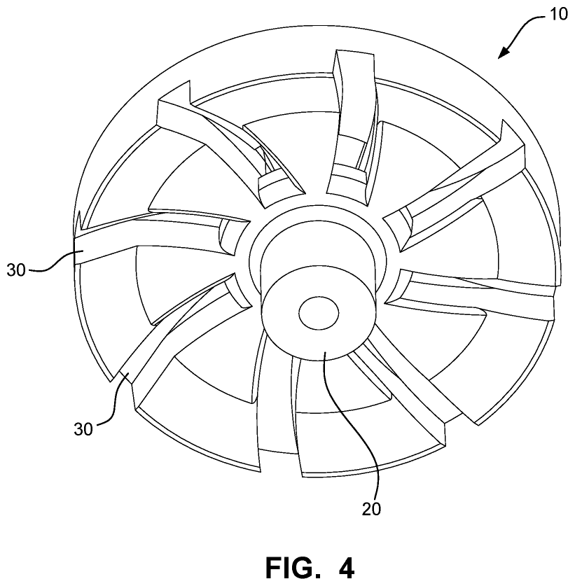

FIG. 3 shows a fluid impact side of the deflector plate 10. That is, the surface shown in FIG. 3 faces the nozzle 18 in use. The deflector plate 10 includes a central opening 24 with a plurality of notches 26 extending radially outward. A flat deflector surface 28 is positioned adjacent the central opening 24 and is recessed below the top surface of the deflector plate 10. A plurality of deflector grooves 30 extend radially outward from the flat deflector surface 28 and in communication with the plurality of notches 26 (FIG. 4).

As shown, the notches 26 are arrayed circumferentially about the central opening 24. Side walls of adjacent ones of the notches meet at a point to define an inward-facing edge or knife edge 32. The inward-facing edges 32 engage the flat deflector surface 28. Outermost walls of the notches 26 extend farther outward than an outermost periphery of the flat deflector surface 28.

With reference to FIG. 4, the deflector grooves 30 are configured to create rotational torque on the deflector plate 10 when water is deflected into the deflector grooves 30 by the flat deflector surface 28. In the configuration shown, the central opening 24 and the notches 26 are disposed on a nozzle-facing side of the deflector plate 10, and the deflector grooves 30 are disposed on an opposite side of the deflector plate 10. The deflector grooves 30 extend through an outer circumference of the deflector plate 10 on the groove side of the deflector plate 10 (i.e., opposite from the nozzle-facing side of the deflector plate 10).

In some embodiments, the flat deflector surface 28 is circular. The notches 26 extend radially outward farther than a circumference of the flat deflector surface 28, thereby creating an open space that allows debris caught on the knife edge 32 to be washed off through the assembly with water flow.

In some embodiments, the deflector plate 10 is downward-facing as shown in FIG. 2. With reference to FIG. 6, a fluid stream exits the nozzle 18 and impacts the flat deflector surface 28. The flat deflector surface 28 deflects the water stream outward evenly into the deflector grooves 30. The knife edges 32 channel the deflected water into the individual grooves 30. The deflected water is captured within each groove 30 and is deflected (upward in FIGS. 2 and 6) to a desired exit angle. Water deflected into each groove 30 travels radially outward and exits out a circumference of the deflector plate 10. As noted, each groove 30 is provided with a specific geometry to create rotational torque, causing the deflector plate 10 to rotate. The central opening 24 and the deflector grooves 30 are configured such that the water stream flows into the central opening 24 on a nozzle-facing side of the deflector plate 10 and exits the deflector grooves 30 on an opposite side (groove side) of the deflector plate 10.

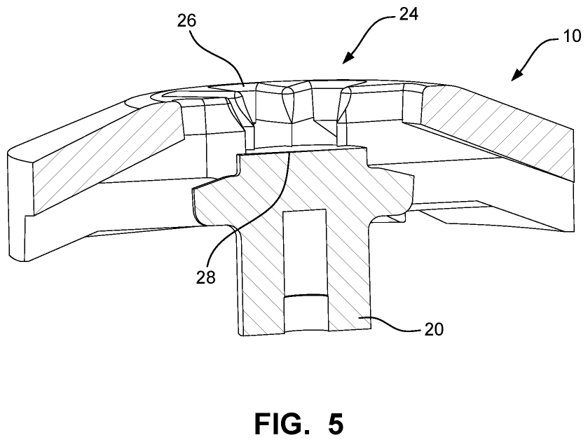

In an exemplary construction, the deflector plate 10 shown in FIGS. 1-6 is a molded, one-piece product.

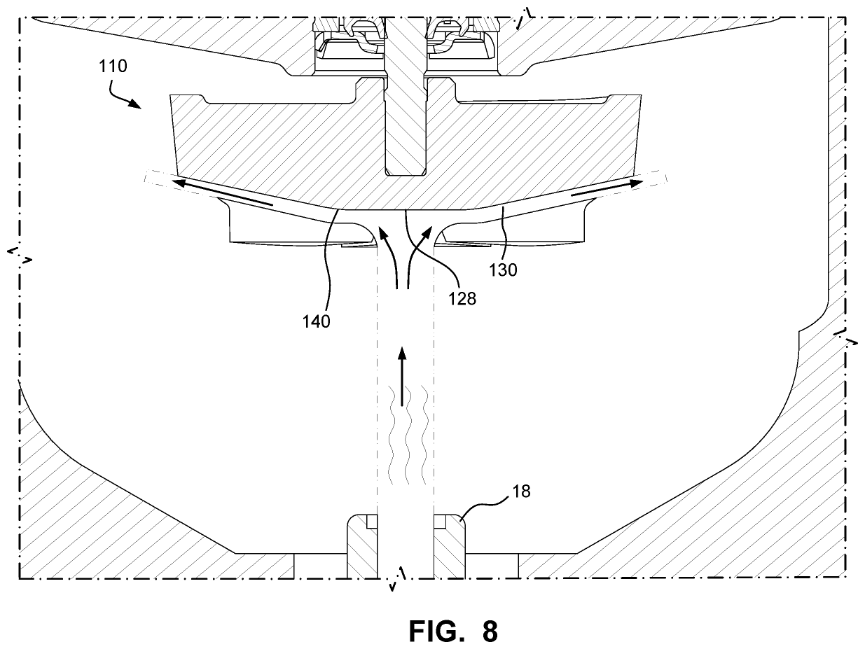

FIGS. 7 and 8 show a variation of the deflector plate 110, where the flat deflector surface 128 deflects the water stream outward into deflector grooves 130 on the same side of the deflector plate 110. That is, the deflector grooves 130 in the variation of the deflector plate 110 shown in FIGS. 7 and 8 are on the nozzle-facing side of the deflector plate 110.

Side walls of adjacent ones of the deflector grooves 130 meet at a point to define an inward-facing edge or knife edge 132. The inward-facing edges 132 surround the flat deflector surface 128. The knife edges 132 channel the deflected water into the individual grooves 130. The deflected water is captured within each groove 130 and is deflected to a desired exit angle. Water deflected into each groove 130 travels radially outward and exits out a circumference of the deflector plate 110. Like the first embodiment, each groove 130 is provided with a specific geometry to create rotational torque, causing the deflector plate 110 to rotate.

With reference to FIG. 8, the deflector plate 110 may be provided with a radiused area 140 in each of the deflector grooves 130 at radial outermost edges of the deflector surface 128. The radiused areas 140 provide a continuous smooth transition for water to adhere to as the water travels outward from the flat deflector surface 128 and through the deflector grooves 130.

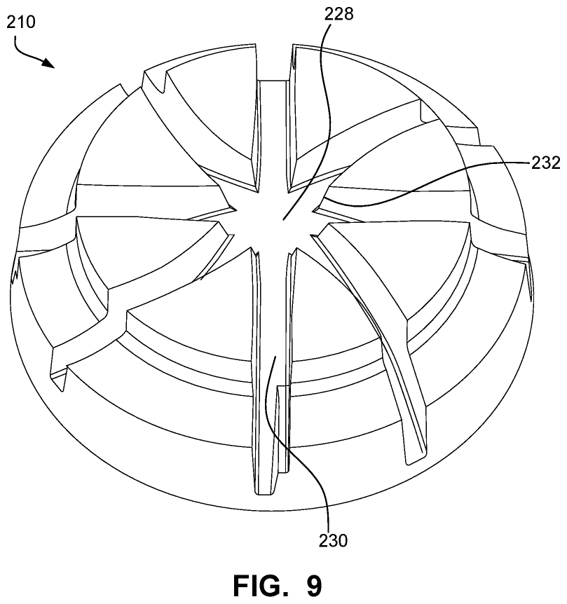

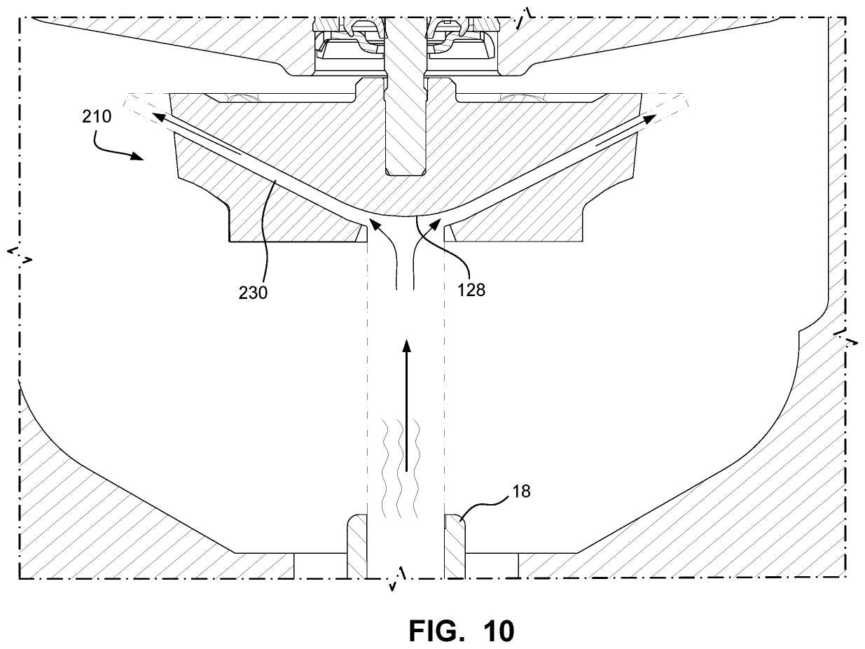

FIGS. 9 and 10 show yet another variation of the deflector plate 210, where the deflector surface 228 is a large radius conical or rounded convex surface at a center of the deflector plate 210. The deflector surface 228 deflects the water stream outward into deflector grooves 230 on the same side of the deflector plate 210. That is, the deflector grooves 230 in the variation of the deflector plate 210 shown in FIG. 9 are on the nozzle-facing side of the deflector plate 210. The rounded convex surface may provide a smoother transition into the grooves as water travels outward from the deflector surface 228.

Side walls of adjacent ones of the deflector grooves 230 meet at a point to define an inward-facing edge or knife edge 232. The inward-facing edges 232 surround the flat deflector surface 228. The knife edges 232 channel the deflected water into the individual grooves 230. The deflected water is captured within each groove 230 and is deflected to a desired exit angle. Water deflected into each groove 230 travels radially outward and exits out a circumference of the deflector plate 210. Each groove 230 is provided with a specific geometry to create rotational torque, causing the deflector plate 210 to rotate.

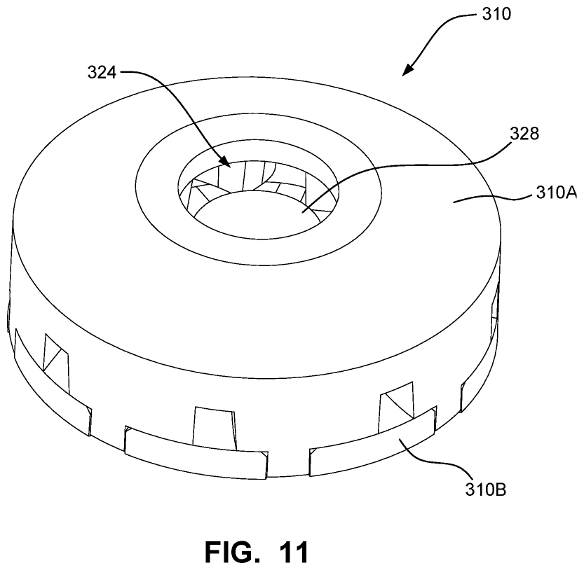

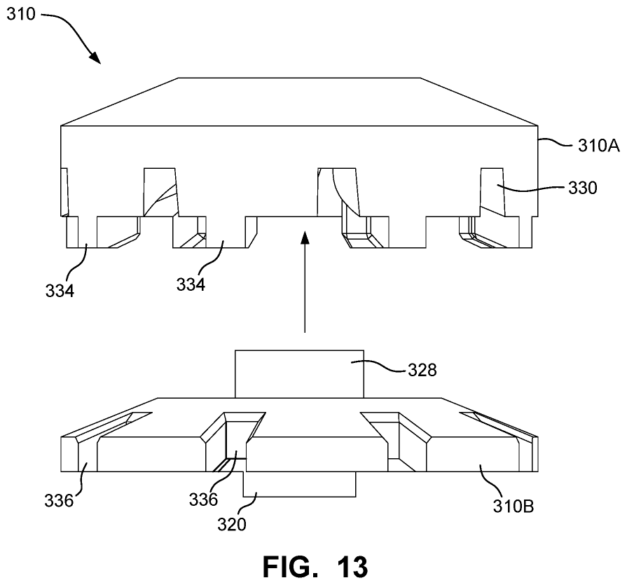

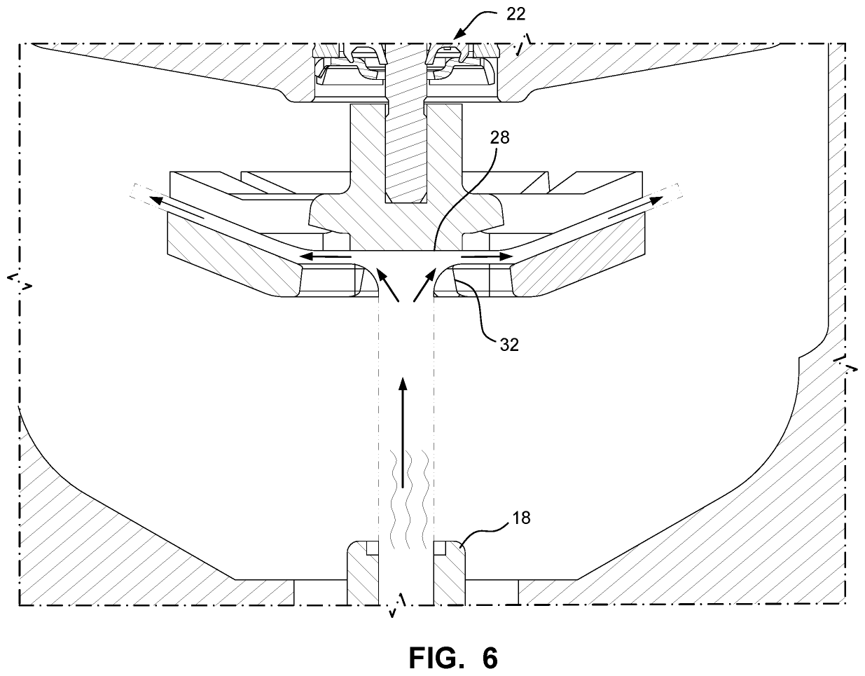

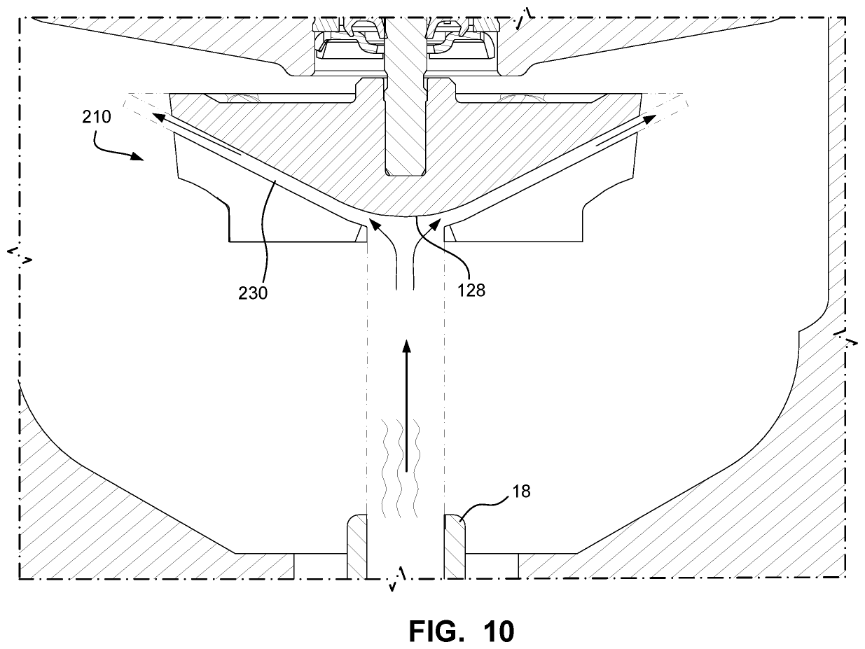

A variation utilizing two pieces is shown in FIGS. 11-13.

The two-piece deflector plate 310 functions identically to the one-piece deflector plate 10 shown in FIGS. 1-6. A first piece 310A includes the central opening 324 and the deflector grooves 330. The first piece 310A also includes connecting tabs 334 for securing the first piece 310A to the second piece 310B.

The second piece 310B includes the flat deflector surface 328 and the rotation hub 320. The second piece 310B is also provided with connecting receptacles 336 for receiving the connecting tabs 334 of the first piece 310A.

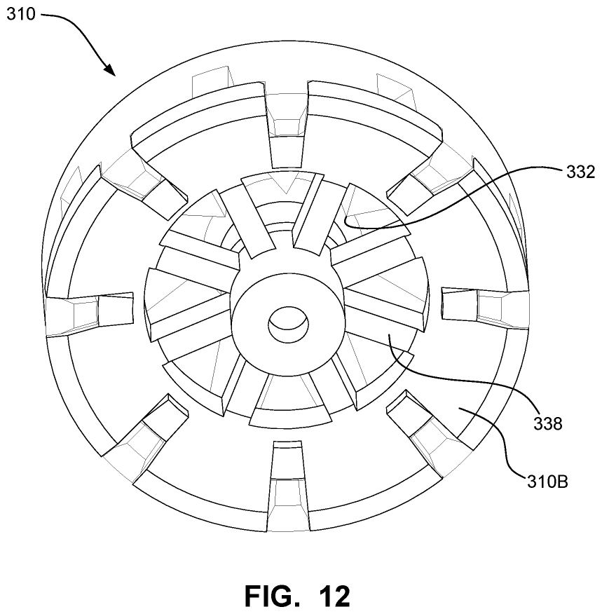

With reference to FIG. 12, the second piece 310B may include spoke geometry 338 for supporting the flat deflector surface 328. The open spaces between the spokes permit debris that may get caught on the knife edges 332 to be washed off and exit the assembly as water travels past.

The deflector plate of the described embodiments incorporates a flat or convex deflector surface that evenly distributes water flow to an array of deflector grooves. The deflector surface reduces side-to-side variations in water supply due to misalignment and/or manufacturing tolerances.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A deflector plate for a sprinkler assembly, the deflector plate comprising:
a central opening with a plurality of notches extending radially outward;
a flat deflector surface positioned adjacent the central opening; and
a plurality of deflector grooves extending radially outward from the flat deflector surface and in communication with the plurality of notches.

2. A deflector plate according to claim 1, wherein the notches are arrayed circumferentially about the central opening, and wherein side walls of adjacent ones of the notches meet at a point to define an inward-facing edge.

3. A deflector plate according to claim 2, wherein radially outermost walls of the notches extend farther outward than an outermost periphery of the flat deflector surface.

4. A deflector plate according to claim 1, wherein the deflector grooves are configured to create rotational torque on the deflector plate when water is deflected into the deflector grooves by the flat deflector surface.

5. A deflector plate according to claim 1, wherein the central opening and the notches are disposed on a nozzle-facing side of the deflector plate, and wherein the deflector grooves are disposed on an opposite side of the deflector plate.

6. A deflector plate according to claim 5, wherein the deflector grooves extend through an outer circumference of the deflector plate on the opposite side of the deflector plate.

7. A deflector plate according to claim 5, further comprising a rotation hub on the opposite side of the deflector plate.

8. A deflector plate according to claim 1, wherein the flat deflector surface is circular.

9. A deflector plate according to claim 1, wherein the notches are spaced from the flat deflector surface.

10. A deflector plate according to claim 1, wherein the central opening and the deflector grooves are configured such that a water stream flowing through the central opening and impacting the flat deflector surface is deflected outward into the deflector grooves.

11. A deflector plate according to claim 10, wherein the central opening and the deflector grooves are configured such that the water stream flows into the central opening on a nozzle-facing side of the deflector plate and exits the deflector grooves on an opposite side of the deflector plate.

12. A deflector plate comprising:
a flat or convex deflector surface; and
a plurality of deflector grooves extending radially outward from the deflector surface,
wherein the deflector surface is configured to deflect water outward into the plurality of deflector grooves.

13. A deflector plate according to claim 12, wherein the deflector surface comprises a flat surface.

14. A deflector plate according to claim 13, comprising a radiused area in each of the deflector grooves at radial outermost edges of the deflector surface.

15. A deflector plate according to claim 12, wherein the deflector surface comprises a rounded convex surface.

16. A deflector plate according to claim 12, comprising a central opening with a plurality of notches extending radially outward, wherein the deflector surface is positioned adjacent the central opening, and wherein the plurality of deflector grooves extend radially outward from the deflector surface and in communication with the plurality of notches.

17. A deflector plate according to claim 16, wherein the central opening and the notches are disposed on a nozzle-facing side of the deflector plate, and wherein the deflector grooves are disposed on an opposite side of the deflector plate.

18. A deflector plate according to claim 12, wherein the deflector surface and the plurality of deflector grooves are disposed on a nozzle-facing side of the deflector plate.

19. A sprinkler comprising:
a base unit coupleable with a source of water under pressure;
a nozzle disposed in the base unit; and
a deflector plate coupled with the base unit and disposed facing the nozzle, the deflector plate including:
a flat or convex deflector surface, and
a plurality of deflector grooves extending radially outward from the deflector surface,
wherein the deflector surface is configured to deflect water outward into the plurality of deflector grooves.

20. A sprinkler according to claim 19, comprising a central opening with a plurality of notches extending radially outward, wherein the deflector surface is positioned adjacent the central opening, and wherein the plurality of deflector grooves extend radially outward from the deflector surface and in communication with the plurality of notches.
